(19) United States
(12) Patent Application Publication
(10) Pub. No.: US 2018/0331973 A1
(43) Pub. Date: Nov. 15, 2018

(54) INCREASING VIRTUAL MACHINE AVAILABILITY DURING SERVER UPDATES

(71) Applicant: Microsoft Technology Licensing, LLC, Redmond, WA (US)

(72) Inventors: Ajay Mani, Woodinville, WA (US); Nisarg T. Sheth, Bothell, WA (US)

(21) Appl. No.: 15/634,998

(22) Filed: Jun. 27, 2017

Related U.S. Application Data
(60) Provisional application No. 62/503,840, filed on May 9, 2017.

(51) Int. Cl. H04L 12/911; H04L 12/24; H04L 29/08; G06F 9/48

(52) U.S. Cl. CPC H04L 47/743; H04L 41/082; G06F 2009/4557; G06F 9/4856; H04L 67/1008

(57) ABSTRACT

Methods, systems, and apparatuses increase virtual machine availability during server updates. A first resource set is designated to include one or more servers needing an update. A first set of virtual machines running on the one or servers in a live manner is migrated from the first resource set to a second resource set to convert the first resource set to an empty resource set, and such that the first set of virtual machines runs in a live manner on the second resource set. The update is performed on the one or more servers of the empty resource set to create an updated empty resource set.

### CROSS REFERENCE TO RELATED APPLICATIONS

This application claims the benefit of U.S. Provisional Application No. 62/503,840, filed on May 9, 2017, titled “Increasing Virtual Machine Availability During Server Updates,” which is incorporated by reference herein in its entirety.

### BACKGROUND

Cloud computing is a form of network-accessible computing that provides shared computer processing resources and data to computers and other devices on demand over the Internet. Cloud computing enables the on-demand access to a shared pool of configurable computing resources, such as computer networks, servers, storage, applications, and services. The resources can be rapidly provisioned and released to a user with reduced management effort relative to the maintenance of local resources by the user. In some implementations, cloud computing and storage enables users, including enterprises, to store and process their data in third-party data centers that may be located far from the user, including distances that range from within a same city to across the world. The reliability of cloud computing is enhanced by the use of multiple redundant sites, where multiple copies of the same applications/services may be dispersed around different data centers (or other cloud computing sites), which enables safety in the form of disaster recovery when some cloud computing resources are damaged or otherwise fail. Each instance of the applications/services may implement and/or manage a set of focused and distinct features or functions on the corresponding server set including virtual machines.

Cloud applications and platforms usually have some notion of fault isolation in them by segregating resources into logical divisions. Each logical division may include a corresponding number and variety of resources, and may be duplicated at multiple sites. Such resources, such as servers, switches, and other computing devices that run software and/or firmware, may need to be periodically updated with the latest software/firmware. Conventionally, updating the latest software/firmware on resources requires shutting down a server and any virtual machines running on the server. After the server has been updated, the server (and the virtual machines running on the server) are rebooted. During this process, the user of the virtual machines can experience sixty minutes of downtime.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Methods, systems, and computer program products are provided for increasing virtual machine availability during server updates. A first resource set is designated to include one or more servers needing an update. A first set of virtual machines running in a live manner on the one or servers is migrated from the first resource set to a second resource set to convert the first resource set to an empty resource set. The first set of virtual machines is migrated to continue running in a live manner on the second resource set. The update is performed on the one or more servers of the empty resource set to create an updated empty resource set.

Further features and advantages of the invention, as well as the structure and operation of various embodiments, are described in detail below with reference to the accompanying drawings. It is noted that the embodiments are not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments of the present application and, together with the description, further serve to explain the principles of the embodiments and to enable a person skilled in the pertinent art to make and use the embodiments.

FIG. 1 shows a block diagram of a system for increasing virtual machine availability during server updates in a network-accessible resource infrastructure, according to an example embodiment.

FIG. 2 shows a flowchart providing a process for increasing virtual machine availability during server updates, according to an example embodiment.

FIG. 3 shows a block diagram of a resource update engine, according to an example embodiment.

FIG. 4 shows a block diagram of a resource update engine, according to another example embodiment.

FIG. 5 shows a flowchart providing a process for repopulating an updated resource set with virtual machines, according to an example embodiment.

FIG. 6 shows a flowchart providing a process for updating a network switch associated with a resource set, according to an example embodiment.

FIGS. 7-9 show flowcharts providing processes for selecting servers for updating, according to example embodiments.

FIG. 10 shows a flowchart providing a process for migrating virtual machines to servers already empty of virtual machines, according to an example embodiment.

FIGS. 11A and 11B show block diagrams illustrating the defragmentation of virtual machines on servers/nodes of a server rack, according to example embodiments.

FIG. 12 shows a flowchart providing a process for migrating virtual machines to servers already hosting running virtual machines, according to an example embodiment.

FIGS. 13A and 13B show block diagrams illustrating the defragmentation of virtual machines on servers/nodes of a server rack, according to example embodiments.

FIG. 14 shows a block diagram of an example computing device that may be used to implement embodiments.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The present specification and accompanying drawings disclose one or more embodiments that incorporate the features of the present invention. The scope of the present invention is not limited to the disclosed embodiments. The disclosed embodiments merely exemplify the present invention, and modified versions of the disclosed embodiments are also encompassed by the present invention. Embodiments of the present invention are defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Furthermore, it should be understood that spatial descriptions (e.g., “above,” “below,” “up,” “left,” “right,” “down,” “top,” “bottom,” “vertical.” “horizontal,” etc.) used herein are for purposes of illustration only, and that practical implementations of the structures described herein can be spatially arranged in any orientation or manner.

In the discussion, unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of the embodiment for an application for which it is intended.

Numerous exemplary embodiments are described as follows. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. Example Embodiments

Cloud computing is a form of network-accessible computing that provides shared computer processing resources and data in a network-accessible resource (e.g., server) infrastructure to computers and other devices on demand over the Internet. Cloud computing enables the on-demand access to a shared pool of configurable computing resources, such as computer networks, servers, storage, applications, and services, which can be rapidly provisioned and released to a user with reduced management effort relative to the maintenance of local resources by the user.

A cloud supporting service is defined herein as the service that manages the network-accessible server infrastructure. Examples of such a supporting service includes Microsoft® Azure®, Amazon Web Services™. Google Cloud Platform™, IBM® Smart Cloud, etc. The supporting service may be configured to build, deploy, and manage applications and services on the corresponding set of servers. For example, a virtual machine (VM) is software that executes in at least one processor circuit of a computing device and is configured to emulate a computer system, being based on a computer architecture and providing functionality of a physical computer. An operating system (OS) may run on top of a virtual machine that, in turn, executes applications, and a hypervisor may be present on the computing device that creates and runs virtual machines, using native execution to share and manage hardware, thereby allowing for multiple environments which are isolated from one another, to yet exist on the same physical machine.

Cloud applications and platforms usually have some notion of fault isolation in them by segregating resources into logical divisions. Each logical division may include a corresponding number and variety of resources (e.g., servers, operating systems, virtual machines, health monitors, network switches, applications, storage devices, etc.), and may be duplicated at multiple sites. Such resources, such as servers, switches, and other computing devices that run software and/or firmware, may need to be periodically updated with the latest software/firmware. Conventionally, updating the latest software/firmware on resources requires shutting down a server and any virtual machines running on the server. After the server has been updated, the server and the virtual machines running on the server are rebooted. During this process, the users of the virtual machines experience downtime which can last minutes, hours, or even longer. This can be very inconvenient to the users, which may include enterprises (e.g., businesses) that rely on the resources to be running to perform computing functions (e.g., providing access to documents, databases, communications applications, marketing applications, websites, etc.).

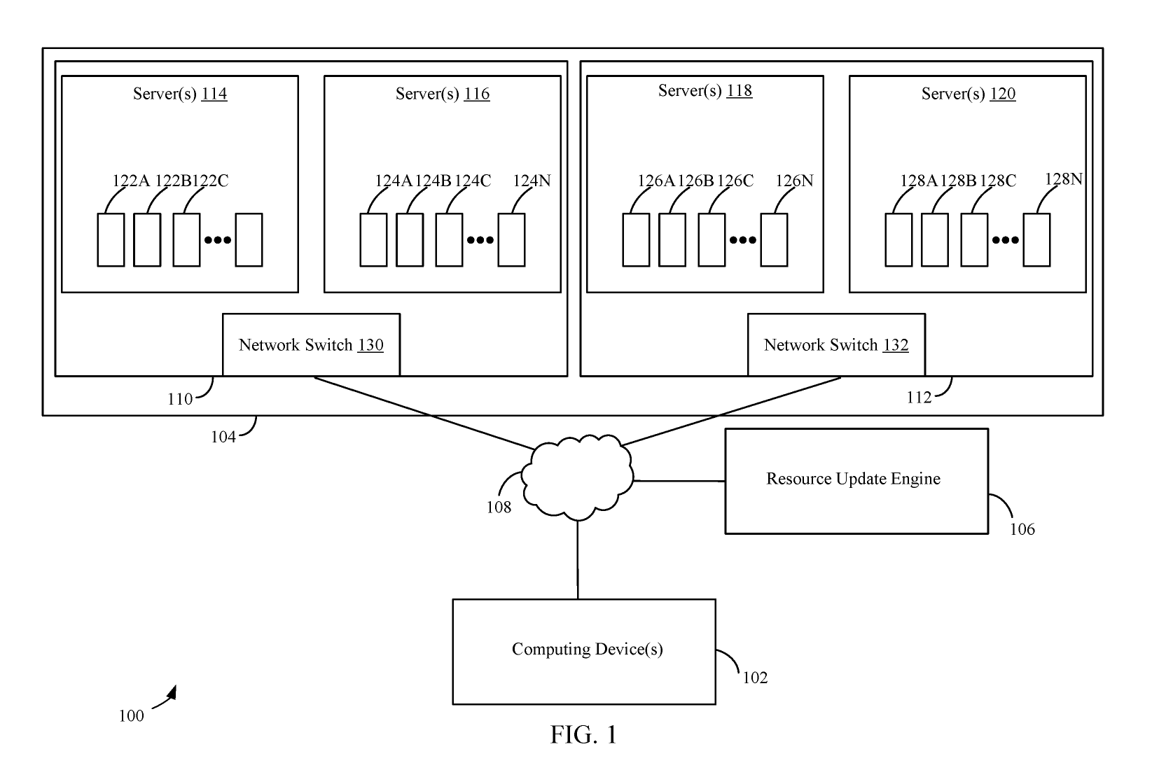

As follows, example embodiments are described that re directed to techniques for increasing resource availability during server updates, including the availability of resources such as virtual machines. For instance. FIG. 1 shows a block diagram of an example system 100 for increasing virtual machine (and/or other resource) availability during server updates, according to an example embodiment. As shown in FIG. 1, system 100 includes a plurality of resource sets 110 and 112, one or more computing devices 102, and resource update engine 106. Resource sets 110 and 112 (and any number of additional resource sets) define a network-accessible server infrastructure 104. In the example of FIG. 1, resource set 110 includes one or more servers 114, one or more servers 116, and a network switch 130, and resource set 112 includes one or more servers 118, one or more servers 120, and a network switch 132. Resource sets 110 and 112, one or more computing devices 102, and resource update engine 106 are communicatively coupled via one or more networks 108. Resource update engine 106 manages updates for resource sets of network-accessible server infrastructure 104 in embodiments. Though resource update engine 106 is shown separate from resource sets 110 and 112, in an embodiment, resource update engine 106 may be included in one or more nodes in one or more of resource sets 110 and 112. Network 108 may comprise one or more networks such as local area networks (LANs), wide area networks (WANs), enterprise networks, the Internet, etc., and may include one or more of wired and/or wireless portions. In an embodiment, resource sets 110 and 112, one or more computing devices 102, and resource update engine 106 may communicate via one or more application programming interfaces (API).

Resource sets 110 and 112 may form a network-accessible server set, such as a cloud computing server network. For example, each of resource sets 110 and 112 may comprise a group or collection of servers (e.g., computing devices) that are each accessible by a network such as the Internet (e.g., in a “cloud-based” embodiment) to store, manage, and process data. For example, as shown in FIG. 1, resource set 110 includes servers 114 and 116, and resource set 112 includes servers 118 and 120 (which each include one or more servers). Each of resource sets 110 and 112 may comprise any number of servers, and may include any type and number of other resources, including resources that facilitate communications with and between the servers, storage by the servers, etc. (e.g., network switches, storage devices, networks, etc.). Servers of a resource set may be organized in any manner, including being grouped in server racks (e.g., 8-40 servers per rack, referred to as nodes or “blade servers”), server clusters (e.g., 2-64 servers, 4-8 racks, etc.), or datacenters (e.g., thousands of servers, hundreds of racks, dozens of clusters, etc.). In an embodiment, the servers of a resource set may be co-located (e.g., housed in one or more nearby buildings with associated components such as backup power supplies, redundant data communications, environmental controls, etc.) to form a datacenter, or may be arranged in other manners. Accordingly, in an embodiment, resource sets 110 and 112 may each be a datacenter in a distributed collection of datacenters.

In accordance with such an embodiment, each of resource sets 110 and 112 may be configured to service a particular geographical region. For example, resource set 110 may be configured to service the northeastern region of the United States, and resource set 112 may be configured to service the southwestern region of the United States. It is noted that the network-accessible server set may include any number of resource sets, and each resource set may service any number of geographical regions worldwide.

Note that the variable “N” is appended to various reference numerals identifying illustrated components to indicate that the number of such components is variable, for example, with any value of 2 and greater. Note that for each distinct component/reference numeral, the variable “N” has a corresponding value, which may be different for the value of “N” for other components/reference numerals. The value of “N” for any particular component/reference numeral may be less than 10, in the 10s, in the hundreds, in the thousands, or even greater, depending on the particular implementation.

Each of server(s) 114, 116, 118, 120 may be configured to execute one or more services (including microservices), applications, and/or supporting services. As shown in FIG. 1, server(s) 114, 116, 118, 120 may each be configured to execute supporting services. A “supporting service” is a cloud computing service/application configured to manage a set of servers (e.g., a cluster of servers in servers 110) to operate as network-accessible (e.g., cloud-based) computing resources for users. Examples of supporting services include Microsoft® Azure®, Amazon Web Services™, Google Cloud Platform™, IBM® Smart Cloud, etc. A supporting service may be configured to build, deploy, and manage applications and services on the corresponding set of servers. Each instance of the supporting service may implement and/or manage a set of focused and distinct features or functions on the corresponding server set, including virtual machines, operating systems, application services, storage services, database services, messaging services, etc. Supporting services may be written in any programming language. Each of server(s) 114, 116, 118, 120 may be configured to execute any number of supporting services, including multiple instances of the same and/or different supporting services.

Computing devices 102 includes the computing devices of users (e.g., individual users, family users, enterprise users, governmental users, etc.) that access network-accessible resource sets 110 and 112 for cloud computing resources through network 108. Computing devices 102 may include any number of computing devices, including tens, hundreds, thousands, millions, or even greater numbers of computing devices. Computing devices of computing devices 102 may each be any type of stationary or mobile computing device, including a mobile computer or mobile computing device (e.g., a Microsoft® Surface® device, a personal digital assistant (PDA), a laptop computer, a notebook computer, a tablet computer such as an Apple iPad™, a netbook, etc.), a mobile phone, a wearable computing device, or other type of mobile device, or a stationary computing device such as a desktop computer or PC (personal computer), or a server. Computing devices 102 may each interface with servers of server(s) 114, 116, 118, 120 through application programming interfaces (API)s and/or by other mechanisms. Note that any number of program interfaces may be present.

Resource update engine 106 performs management functions for resource sets 110 and 112 including managing updates. Resource update engine 106 is configured to increase virtual machine availability of virtual machines 122A-122N, 124A-124N, 126A-126N, 128A-128N, etc., operating within resource sets 110 and 112 during updates. For instance, resource update engine 106 may designate one or more servers of server(s) 114, 116, 118, 120 as a first resource set for an update, and accordingly may migrate virtual machines (e.g., one or more of 122A-122N, 124A-124N, 126A-126N, and 128A-128N) running on the designated server(s) in a live manner to a second resource set to convert the servers of the first resource set to an empty resource set, and such that the migrated virtual machines run in a live manner on the second resource set. Migrating a virtual machine in a live manner may include moving the memory, session state, storage, network connectivity, and/or any other necessary attributes of the running virtual machine from the first server set to the second server set without substantial perceived downtime, including limiting the downtime to a couple of seconds or less. In this manner, a user of an application executing on a live running virtual machine suffers no significant loss of application/virtual machine functionality, and in fact may perceive no downtime at all. Resource update engine 106 is configured to perform the update (e.g., software and/or firmware update) on the server(s) emptied resource set to create an updated empty resource set. Resource update engine 106 may then designate virtual machines for invoking on and/or moving to the updated empty resource set.

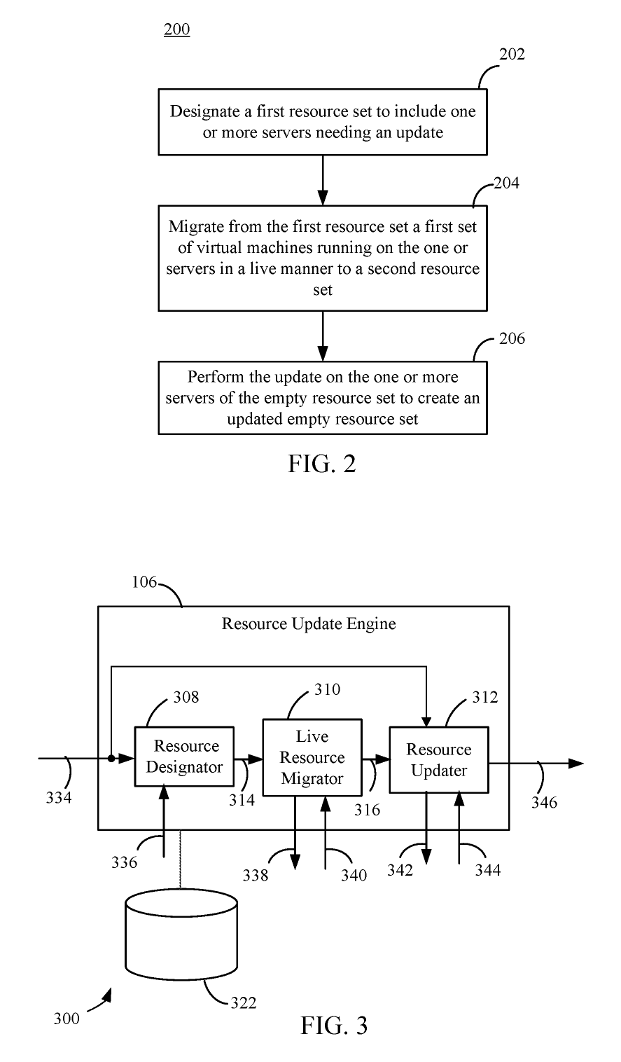

Accordingly, embodiments enable an increased virtual machine availability during server updates in network-accessible server infrastructure 108. Resource update engine 106 may increase virtual machine availability during server updates in various ways. For instance, FIG. 2 shows a flowchart 200 for increasing virtual machine availability during server updates to network-accessible server infrastructure 104, according to an example embodiment. In an embodiment, flowchart 200 may be implemented by resource update engine 106. FIG. 2 is described with continued reference to FIG. 1. Other structural and operational embodiments will be apparent to persons skilled in the relevant art(s) based on the following discussion regarding flowchart 200 and system 100 of FIG. 1.

Flowchart 200 begins with step 202. In step 202, a first resource set is designated to include one or more servers needing an update. For example, with reference to FIG. 1, resource update engine 106 designates the servers of servers 114 and 116 for update. Resource update engine 106 may determine that the servers need a software and/or firmware update in various ways, such as by comparing software/firmware versions (e.g., comparing the update version against versions installed at the servers), install dates, file names, etc., which indicate that the software/firmware update is needed.

In step 204, the first set of virtual machines running on the one or servers in a live manner is migrated to a second resource set to convert the first resource set to an empty resource set, and such that the first set of virtual machines runs in a live manner on the second resource set. For instance, with reference to FIG. 1, virtual machines 122A-122N, 124A-124N may be running in a live manner, meaning that their underlying software executes in servers 114 and 116, such that users may be accessing/using the functionality of virtual machines 122A-122N, 124A-124N in real time. As such, resource update engine 106 may migrate virtual machines 122A-122N, 124A-124N running on server(s) 114, 116 of first resource set 110 in a live manner to a second resource set to convert resource set 110 to an empty resource set, and such that the set of virtual machines 122A-122N, 124A-124N runs in a live manner on the second resource set.

As described above, resource update engine 106 is configured to perform “live migration” of virtual machines such that users of the virtual machines suffer no substantial downtime (e.g., downtime in terms of a couple of seconds or less) in their live use of the virtual machines. In an embodiment, resource update engine 106 is configured to perform the “live migration” such that the virtual machines are migrated from the first resource set to a second resource set that has already been updated. In this manner, virtual machines may be migrated to resources that run newer software, while the first resource set is emptied and made available for updating.

Note that in one embodiment, the second resource set is empty of virtual machines prior to migrating the first set of virtual machines running on the server(s) in a live manner to the second resource set to run in a live manner on the second resource set. In this instance, the migrated virtual machines have access to all capacity (e.g., processing, storage, etc.) of the second resource set. In another embodiment, the second resource set contains at least one running virtual machine prior to migrating the first set of virtual machines running on the one or servers in a live manner to the second resource set to run in a live manner on the second resource set. In this alternative, the migrated virtual machines share capacity of the second resource set (e.g., memory, processing cores, etc.) with the already present virtual machine(s) (e.g., to co-run in a live manner with the running virtual machine(s)).

Referring back to flowchart 200 in FIG. 2, in step 206, the update is performed on the one or more servers of the empty resource set to create an updated empty resource set. For instance, with reference to FIG. 1, resource update engine 106 is configured to perform the update on server(s) 114, 116 of now empty resource set 110 to create an updated empty resource set out of resource set 110. The update may include the installation of new software and/or firmware, the replacement of existing software and/or firmware with updated software and/or firmware (e.g., updated version), the removal of software and/or firmware (e.g., unused components), and/or any other types of updates.

Note that resource update engine 106 may be configured in various ways to perform its functions, including performing flowchart 200 of FIG. 2. For instance, FIG. 3 shows a block diagram of resource update engine 106 of FIG. 1, according to an example embodiment. As shown in FIG. 3, resource update engine 106 includes a resource designator 308, a live resource migrator 310, and a resource updater 312, and is coupled to a storage device 322. Resource update engine 106 of FIG. 3 is described as follows.

Resource designator 308 may be configured to perform step 202 of flowchart 200, including being configured to designate a first server set that includes one or more servers needing an update. Resource designator 308 may designate such a set of servers one server at a time, may search for a block of related servers needing update, and/or may designate the servers for the first server set in any manner. Resource designator 308 may access information regarding the operational state of a server (e.g., a record stored in storage device 322 of virtual machines running on the server) and/or may obtain the state via a request directly to the server, and may use this information to determine whether the server is a candidate for update. For instance, as shown in FIG. 3, resource designator 308 may receive an update indication 334, which indicates a software and/or firmware update to be provided to servers (including software/firmware versions, etc.), and state indications 336, which indicates the states of one or more candidate servers (e.g., servers of resource sets 110 and 112 in FIG. 1) to be potentially updated. As shown in FIG. 3, resource designator 308 generates a server update list 314 that lists the servers designated for update.

Storage device 322 may include a hardware media such as the hard disk associated with hard disk drive, removable magnetic disk, removable optical disk, other physical hardware media such as RAMs, ROMs, flash memory cards, digital video disks, zip disks, MEMs, nanotechnology-based storage devices, and further types of physical/tangible hardware storage media.

Live resource migrator 310 may be configured to perform step 204 of flowchart 200, including being configured to empty the servers designated by resource designator 308 of live virtual machines so that the designated servers may be updated. As shown in FIG. 3, live resource migrator 310 receives server update list 314. Live resource migrator 310 is configured to migrate a first set of virtual machines running in a live manner on the one or servers of server update list 314 to a second resource set. As shown in FIG. 3, live resource migrator 310 generates migration instructions 338 that are transmitted to the servers designated in server update list 314. Migration instruction 338 includes instructions (e.g., copy memory pages, transfer state, transfer register values, stop execution, restart execution, etc.) for migrating virtual machines between servers in a live manner. Live resource migrator 310 receives migration status indications 340 that indicate the status of the migration between servers, including indications of failures and/or completed migrations. Live resource migrator 310 generates an emptied server indication 316, which indicates the server(s) that were emptied of virtual machines (“emptied servers”).

To migrate a virtual machine from source server to a destination server in a live manner, live resource migrator 310 may move the memory, session state, storage, network connectivity, and/or any other necessary attributes of the running virtual machine from source server to the destination server without substantial perceived downtime, including limiting the virtual machine downtime to a couple of seconds or less.

Live resource migrator 310 may implement one or more live migration techniques to migrate virtual machines. In one embodiment, to migrate a virtual machine in a live manner, live resource migrator 310 may copy all the memory pages associated with the virtual machine from the source server to the destination server while the virtual machine still runs on the source server, stop execution of the virtual machine on the source server, copy any dirty pages (changed memory pages since originally copying the memory pages), and then restart execution of the virtual machine on the destination server. In another embodiment, live resource migrator 310 may pause execution of the virtual machine on the source server, transfer the execution state (e.g., CPU state, registers, non-pageable memory, etc.) to the destination server, and then restart execution of the virtual machine on the destination server, while concurrently pushing the remaining memory pages from the source server to the destination server. Other techniques may be used for live migration by live resource migrator 310, as would be known to persons skilled in the relevant art(s).

Resource updater 312 of FIG. 3 may be configured to perform step 206 of flowchart 200, including being configured to perform the update on the one or more servers of the empty resource set to create an updated empty resource set. As shown in FIG. 3, resource updater 312 receives update indication 334 and emptied server indication 316. Resource updater 312 is configured to apply the software and/or firmware update indicated in update indication 334 to the servers emptied of virtual machines listed in emptied server indication 316. Resource updater 312 may apply the software and/or firmware update(s) in any manner as would be known to persons skilled in the relevant art(s), including copying software/firmware update files to the emptied servers, deleting and/or writing over no longer needed files on the emptied servers, bringing down the emptied servers (e.g., halting OS operation, etc.), restarting/rebooting the emptied servers, configuring the software/firmware update on the emptied servers, etc. In an embodiment, resource updater 312 is configured to generate an updated server state 346, which indicates the emptied servers as having been updated, and may store updated server state 346 in memory storage device 322, provide (e.g., display) updated server state 346 to a server administrator, etc.

By updating software/firmware on servers after migrating virtual machines in a live manner from the servers, the users of the virtual machines suffer no substantial downtime, while the servers being updated can be shut down, rebooted, restarted, etc., as needed for the update without affecting the virtual machine users.

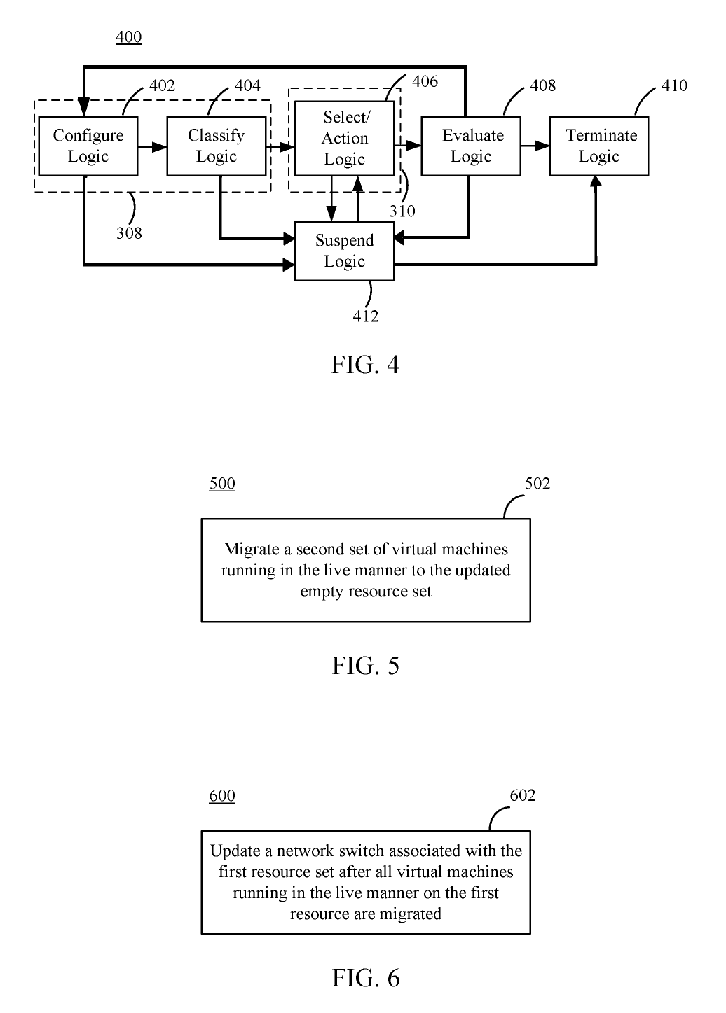

Note that resource update engine 106 of FIG. 3 may be implemented in various ways in embodiments. For instance, FIG. 4 shows a block diagram of resource update engine 106, according to another example embodiment. As shown in FIG. 4, resource update engine 106 may include a configure logic 402, a classify logic 404, a select/action logic 406, an evaluate logic 408, a terminate logic 410, and a suspend logic 412. Configure logic 402 and classify logic 404 are an example of (e.g., may be included in) resource designator 308 of FIG. 3. Select/action logic 406 is an example of live resource migrator 310 of FIG. 3. In an embodiment, select/action logic 406 also performs the functions of resource updater 312. Alternatively, select/action logic 406 communicates with resource updater 312 to perform updates on servers after live migration of virtual machines from those servers by select/action logic 406. Resource update engine 106 of FIG. 4 is described as follows.

Configure logic 402 and classify logic 404 may be configured to designate a first resource set to include one or more servers needing an update, as indicated in step 202 of flowchart 200 (FIG. 2). The resource set may be a predetermined collection of servers (e.g., resource set 110 or 112 of FIG. 1), or configure logic 402 and 404 may assemble a listing of servers at varying locations and/or of varying configurations into a resource set containing servers to be updated. For example, configure logic 402 may be configured to select a resource (e.g., a server) from a plurality of resources to be updated and to notify other components of resource update engine 106 that the resource should or should not be selected as a candidate resource for receiving virtual machines (e.g., based on a number of virtual machines running on the server, software/firmware versions on the server, etc.). Configure logic 402 may also be configured to determine based on capacity how many resources of the plurality of resources can be scheduled to be updated at a same time. Classify logic 404 may be configured to determine whether a resource is live migratable (e.g., based on server workload criticality, virtual machine age, etc., as described in further detail elsewhere herein). For example, classify logic 404 may categorize one or more servers, including individual servers, a rack of servers, a server cluster, etc., for being included into a resource set to be updated, or for not being available to be updated.

Select/action logic 406 may be configured to migrate from the resource set (designated by configure logic 402 and classify logic 404) a set of virtual machines running on the servers in a live manner to a second resource set (e.g., as in step 204 of FIG. 2). For example, select/action logic 406 may select/designate the servers to be migrated (e.g., a sequence of server migrations), as well as to migrate the running virtual machines from the selected/designated servers in a live manner. Evaluate logic 408 may be configured to determine whether the live migration and/or update of each resource of a resource set has completed. Terminate logic 410 is configured to end the update process once the update of one or more resource sets is complete. Suspend logic 412 may be configured to suspend the live migration on a resource for one or more reasons, such as if a higher priority process is allocated to the resource, if the update is found to be detrimental to the health of the resource, etc.

In other embodiments, resource update engine 106 may be configured in other ways, as would be apparent to persons skilled in the relevant art(s) from the teachings herein.

After live migration and updating of servers is performed (e.g., according to the embodiments of FIGS. 2-4), the updated servers may receive virtual machines for hosting. For instance, FIG. 5 shows a flowchart 500 for repopulating an updated resource set with virtual machines, according to an example embodiment. Flowchart 500 may be implemented by resource update engine 106 of FIGS. 1 and 3, in embodiments. In an embodiment, flowchart 500 is a continuation of flowchart 200 of FIG. 2. Flowchart 500 is described as follows. Other structural and operational embodiments will be apparent to persons skilled in the relevant art(s) base on the following discussion regarding flowchart 500.

Flowchart 500 includes step 502. In step 502, a second set of virtual machines running in the live manner is migrated to the updated empty resource set. For example, with reference to FIG. 3, live resource migrator 310 may be configured to migrate a second set of virtual machines running in the live manner to the updated empty resource set. The second set of virtual machines may be new virtual machines, may be migrated from other servers, and/or may have any other source. In this manner, the second set of virtual machines may run on the updated servers, offering any benefits of the software/firmware update to users of those virtual machines.

Updates of software and/or firmware may be performed by resource updater 312 on further types of resources after the live migration by live resource migrator 310. For instance, FIG. 6 shows a flowchart 600 for updating a network switch associated with a resource set, according to an example embodiment. Flowchart 600 may be implemented by resource update engine 106 of FIGS. 1 and 3, in embodiments. Flowchart 600 is described as follows. Other structural and operational embodiments will be apparent to persons skilled in the relevant art(s) base on the following discussion regarding flowchart 600.

Flowchart 600 includes step 602. In step 602, a network switch associated with the first resource set is updated after all virtual machines running in the live manner on the first resource are migrated. For example, as shown in FIG. 1, resource set 110 includes network switch 130. Network switch 130 provides network connectivity for servers 114 and 116 of resource set 110, including communicatively coupling resource set 110 to network 108 (and therefore to computing devices 102 and resource update engine 106. Resource set 110 may include any number of routers, bridges, network switches, and/or other network appliances in addition to network switch 130. Network switch 132 is configured to provide similar functionality for resource set 112.

With reference to FIG. 3, resource updater 312 may be configured to install a software and/or firmware update to a network switch servicing servers that have been emptied of virtual machines as described herein. In this manner, the update to the network switch, which may cause network downtime for the associated servers, does not impact any running virtual machines. Thus, with reference to FIG. 1, if all servers of first resource set 110 are emptied of virtual machines (e.g., according to step 204 of FIG. 2), resource updater 312 may be configured to (e.g., network switch 130 associated with server(s) 114, 116 of resource set 110) update the firmware and/or software of network switch 130. By updating network switch 130 after live migration, network switch 130 no longer has to support network traffic for the migrated virtual machines, and can safely become non-operational during its updating.

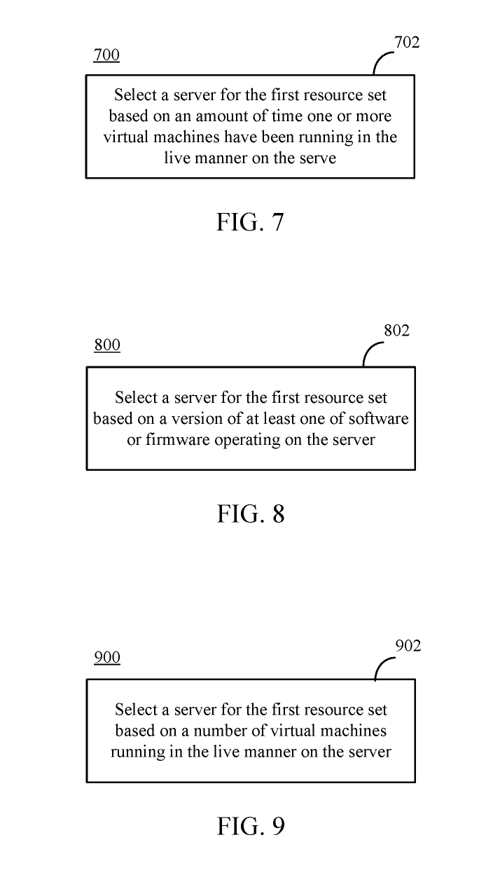

Note that the selecting of servers (step 202 of FIG. 2) for inclusion in a resource set to be live migrated may be performed in various ways in embodiments. For instance, FIGS. 7-9 show flowcharts providing processes for selecting servers for updating, according to example embodiments. FIGS. 7-9 are described as follows.

For instance, FIG. 7 shows a flowchart 700 for selecting servers based on virtual machine runtime. In an embodiment, flowchart 700 may be implemented by resource designator 308 of resource update engine 106, as shown in FIG. 3. Other structural and operational embodiments will be apparent to persons skilled in the relevant art(s) based on the following discussion regarding flowchart 700.

Flowchart 700 includes step 702. In step 702, a server for the first resource set is selected based on an amount of time one or more virtual machines have been running in the live manner on the server. For example, with reference to FIG. 3, resource designator 308 may be configured to select a server for the first resource set based on an amount of time one or more virtual machines have been running in the live manner on the server. For instance, if virtual machines have been running for a long time, those virtual machines are more likely to be virtual machines that will continue to be used (e.g., the customer owner of the virtual machines has shown their importance by their continued usage). Virtual machines running for a relatively short period of time are less likely to be continued to be used, and thus may be better candidates for not being migrated (e.g., higher chance that a server with virtual machines running for relatively short periods of time will become free of virtual machines without intervention). Accordingly, resource designator 308 may select servers hosting virtual machines running for longer amounts of time over servers hosting virtual machines running for relatively shorter amounts of time.

FIG. 8 shows a flowchart 800 for selecting servers based on software/firmware versions. In an embodiment, flowchart 800) may be implemented by resource designator 308 of resource update engine 106, as shown in FIG. 3. Other structural and operational embodiments will be apparent to persons skilled in the relevant art(s) based on the following discussion regarding flowchart 800.

Flowchart 800 includes step 802. In step 802, a server for the first resource set is selected based on a version of at least one of software or firmware operating on the server. For example, with reference to FIG. 3, resource designator 308 may be configured to select a server for the first resource set based on a version of at least one of software or firmware operating on the server. For instance, in an embodiment, it may be desirable to designate servers for upgrade that run the most-out of date versions of software/firmware, relative to servers that run more current versions of the software/firmware.

FIG. 9 shows a flowchart 900 for selecting servers based on numbers of running virtual machines. In an embodiment, flowchart 900 may be implemented by resource designator 308 of resource update engine 106, as shown in FIG. 3. Other structural and operational embodiments will be apparent to persons skilled in the relevant art(s) based on the following discussion regarding flowchart 900.

Flowchart 900 includes step 902. In step 902, a server for the first resource set is selected based on a number of virtual machines running in the live manner on the server. For example, with reference to FIG. 3, resource designator 308 may be configured to select a server for the first resource set based on a number of virtual machines running in the live manner on the server. For instance, in an embodiment, it may be desirable to migrate live virtual machines from servers executing fewer virtual machines relative to others to decrease the number of virtual machines that may be possibly disrupted by the migration and allow for faster turnaround periods in creating empty resources (e.g., the fewer the virtual machines on a server, the less time it takes to empty the server).

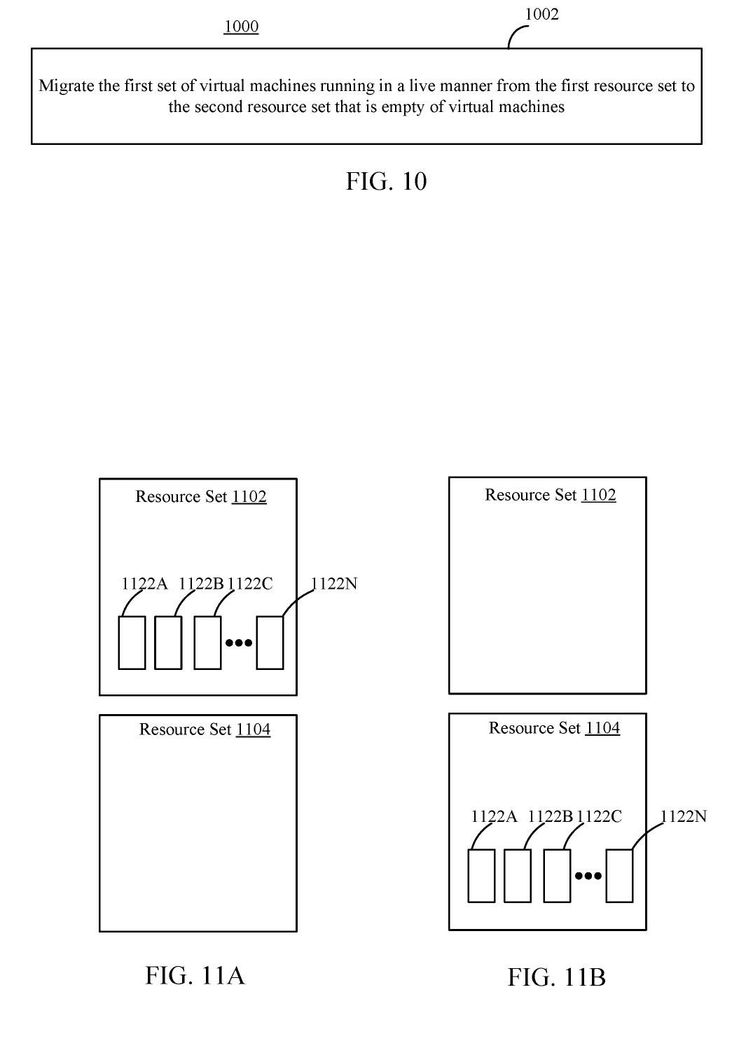

Note that as described with respect to FIGS. 10, 11A, 11B, 12, 13A, and 13B as follows, virtual machines may be live migrated to a resource set containing servers that are empty of virtual machines and to a resource set containing servers that contain running virtual machines.

For instance. FIG. 10 shows a flowchart 1000 providing a process for migrating virtual machines to servers already empty of virtual machines, according to an example embodiment. Flowchart 1000 may be implemented by resource update engine 106 of FIGS. 1 and 3, in embodiments. In an embodiment, flowchart 1000 may be performed during step 204 of flowchart 200 of FIG. 2. Flowchart 1000 is described as follows. Other structural and operational embodiments will be apparent to persons skilled in the relevant art(s) base on the following discussion regarding flowchart 1000.

Flowchart 1000 includes step 1002. In step 1002, the first set of virtual machines running in a live manner is migrated from the first resource set to the second resource set that already includes at least one virtual machine running in a live manner. For example, as described above with respect to FIG. 3, live resource migrator 310 is configured to migrate virtual machines running on one or more servers in a live manner to a second resource set. In an embodiment, that second resource set may be empty of virtual machines. This is illustrated with respect to the example of FIGS. 11A and 11B. FIGS. 11A and 11B each show a view of first and second resource sets 1102 and 1104 during live migration of virtual machines from resource set 1102 to resource set 1104. FIGS. 11A and 11B are described as follows.

Resource sets 1102 and 1104 each include one or more servers (not shown in FIGS. 11A and 11B for purposes of brevity) capable of running virtual machines. In FIG. 11A, virtual machines 1122A-1122N are running in a live manner on resource set 1102. Resource set 1104 includes no running virtual machines. Virtual machines of resource set 1104 may have been previously migrated from resource set 1104 (e.g., according to step 204 of FIG. 2), or no virtual machines may have previously run on resource set 1104. In FIG. 11B, resource set 1102 is emptied by migrating virtual machines 1122A-1122N to resource set 1104. In this manner, servers and other resources (e.g., network switches, etc.) of resource set 1102 may be updated without disrupting virtual machines 1122A-1122N (now running live on resource set 1104). With no virtual machines running on resource set 1104 prior to the migration, virtual machines 1122A-1122N migrated to resource set 1104 do not have to compete with other virtual machines for processor time and other features of the servers of resource set 1104.

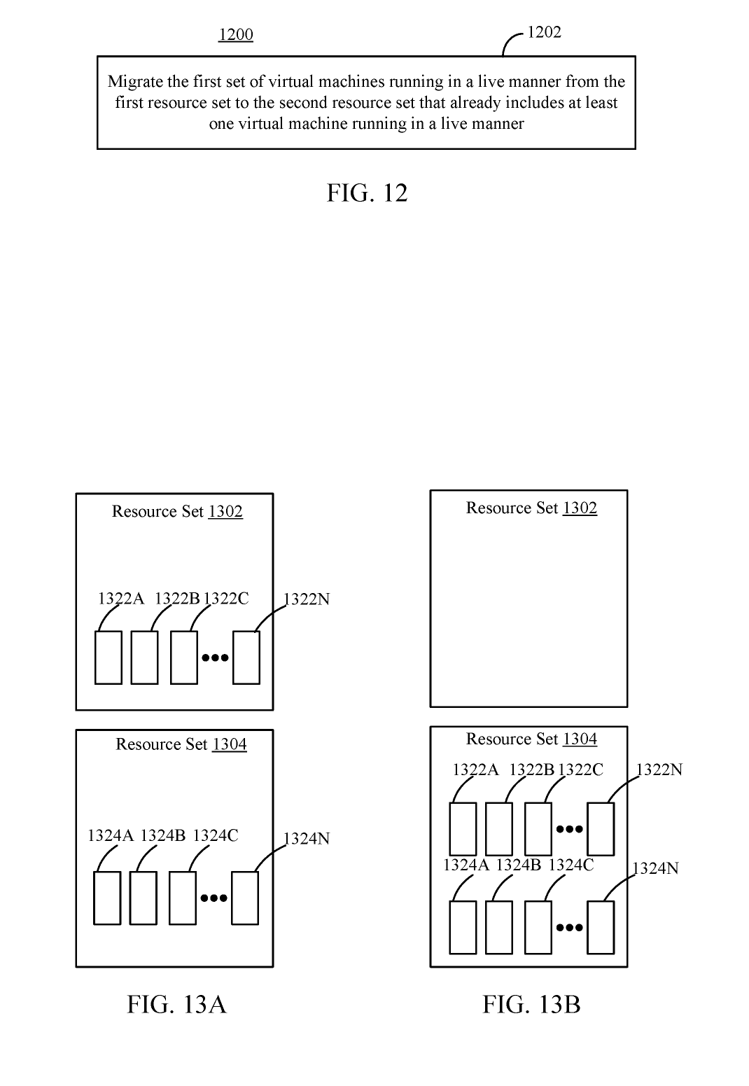

FIG. 12 shows a flowchart 1200 providing a process for migrating virtual machines to servers already hosting running virtual machines, according to an example embodiment. Flowchart 1200 may be implemented by resource update engine 106 of FIGS. 1 and 3, in embodiments. In an embodiment, flowchart 1000 may be performed during step 204 of flowchart 200 of FIG. 2. Flowchart 1200 is described as follows. Other structural and operational embodiments will be apparent to persons skilled in the relevant art(s) base on the following discussion regarding flowchart 1200.

Flowchart 1200 includes step 1202. In step 1202, the first set of virtual machines running in a live manner is migrated from the first resource set to the second resource set that already includes at least one virtual machine running in a live manner. For example, with reference to FIG. 3, live resource migrator 310 is configured to migrate virtual machines running on one or more servers in a live manner to a second resource set. In an embodiment, that second resource set may already be running virtual machines. This is illustrated with respect to the example of FIGS. 13A and 13B. FIGS. 13A and 13B each show a view of first and second resource sets 1302 and 1304 during live migration of virtual machines from resource set 1302 to resource set 1304. FIGS. 13A and 13B are described as follows.

Resource sets 1302 and 1304 each include one or more servers (not shown in FIGS. 13A and 13B for purposes of brevity) capable of running virtual machines. In FIG. 13A, virtual machines 1322A-1322N are running in a live manner on resource set 1302, and virtual machines 1324A-1324N are running in a live manner on resource set 1304. In FIG. 13B, resource set 1304 is emptied by migrating virtual machines 1322A-1322N to resource set 1304. In this manner, servers and other resources (e.g., network switches, etc.) of resource set 1302 may be updated without disrupting virtual machines 1322A-1322N (now running live on resource set 1304). With virtual machines 1324A-1324N already running on resource set 1304 prior to the migration, virtual machines 1322A-1322N migrated to resource set 1304 have to share processor time and other features of the servers of resource set 1304 with virtual machines 1324A-1324N.

Note that in embodiments, the migration of virtual machines by live resource migrator 310 may be performed as a form of “defragmentation.” FIGS. 13A and 13B illustrate one example of such defragmentation at the resource set level, where the number of resource sets running virtual machines is consolidated/reduced from two resource sets to a single resource set. Such defragmentation may also be performed at the server/node level, such that virtual machines running live on a first collection of servers may be consolidated to run live on a relatively smaller second collection of servers to reduce the total number of servers hosting virtual machines (the first and second collections may overlap).

In one example, virtual machines may be migrated from servers containing relatively fewer numbers of virtual machines to servers already running greater numbers of virtual machines in an effort to consolidate virtual machines to a smallest number of servers able to accommodate the virtual machines while minimizing the number of virtual machines migrated. In this manner, a greatest number of servers are emptied for update, while concentrating any disruption due to the migration to the fewest virtual machines. Such defragmentation may be performed over any number of servers.

### III. Example Computer System Implementation

Computing device(s) 102, resource update engine 106, resource sets 110 and 112, servers 114, 116, 118, and 120, network switch 130, network switch 132, resource designator 308, live resource migrator 310, resource updater 312, configure logic 402, classify logic 404, select/action logic 406, evaluate logic 408, terminate logic 410, suspend logic 412, resource sets 1102 and 1104, resource sets 1302 and 1304, flowchart 200, flowchart 500, flowchart 600, flowchart 700, flowchart 800, flowchart 900, flowchart 100, and flowchart 1200 may be implemented in hardware, or hardware combined with software and/or firmware. For example, resource update engine 106, resource designator 308, live resource migrator 310, resource updater 312, configure logic 402, classify logic 404, select/action logic 406, evaluate logic 408, terminate logic 410, suspend logic 412, flowchart 200), flowchart 500, flowchart 600, flowchart 700, flowchart 800, flowchart 900, flowchart 1000, and flowchart 1200 may be implemented as computer program code/instructions configured to be executed in one or more processors and stored in a computer readable storage medium. Alternatively, resource update engine 106, resource designator 308, live resource migrator 310, resource updater 312, configure logic 402, classify logic 404, select/action logic 406, evaluate logic 408, terminate logic 410, suspend logic 412, flowchart 200, flowchart 500, flowchart 600, flowchart 700, flowchart 800, flowchart 900, flowchart 1000, and/or flowchart 1200 may be implemented as hardware logic/electrical circuitry.

For instance, in an embodiment, one or more, in any combination, of resource update engine 106, resource designator 308, live resource migrator 310, resource updater 312, configure logic 402, classify logic 404, select/action logic 406, evaluate logic 408, terminate logic 410, suspend logic 412, flowchart 200, flowchart 500, flowchart 600, flowchart 700, flowchart 800, flowchart 900, flowchart 1000, and flowchart 1200 may be implemented together in a SoC. The SoC may include an integrated circuit chip that includes one or more of a processor (e.g., a central processing unit (CPU), microcontroller, microprocessor, digital signal processor (DSP), etc.), memory, one or more communication interfaces, and/or further circuits, and may optionally execute received program code and/or include embedded firmware to perform functions.

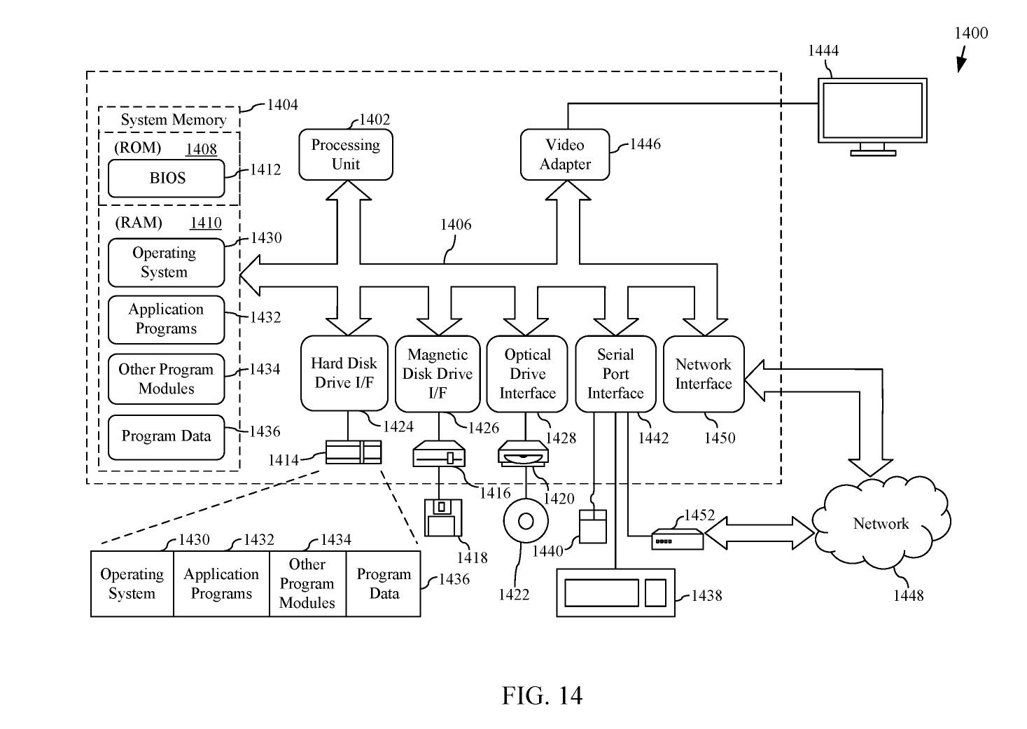

FIG. 14 depicts an exemplary implementation of a computing device 1400 in which embodiments may be implemented. For example, computing device(s) 102, server(s) 114, 116, 118, 120, and/or resource update engine 106 may each be implemented in one or more computing devices similar to computing device 1400 in stationary or mobile computer embodiments, including one or more features of computing device 1400 and/or alternative features. The description of computing device 1400 provided herein is provided for purposes of illustration, and is not intended to be limiting. Embodiments may be implemented in further types of computer systems, as would be known to persons skilled in the relevant art(s).

As shown in FIG. 14, computing device 1400 includes one or more processors, referred to as processor circuit 1402, a system memory 1404, and a bus 1406 that couples various system components including system memory 1404 to processor circuit 1402. Processor circuit 1402 is an electrical and/or optical circuit implemented in one or more physical hardware electrical circuit device elements and/or integrated circuit devices (semiconductor material chips or dies) as a central processing unit (CPU), a microcontroller, a microprocessor, and/or other physical hardware processor circuit. Processor circuit 1402 may execute program code stored in a computer readable medium, such as program code of operating system 1430, application programs 1432, other programs 1434, etc. Bus 1406 represents one or more of any of several types of bus structures, including a memory bus or memory controller, a peripheral bus, an accelerated graphics port, and a processor or local bus using any of a variety of bus architectures. System memory 1404 includes read only memory (ROM) 1408 and random access memory (RAM) 1410. A basic input/output system 1412 (BIOS) is stored in ROM 1408.

Computing device 1400 also has one or more of the following drives: a hard disk drive 1414 for reading from and writing to a hard disk, a magnetic disk drive 1416 for reading from or writing to a removable magnetic disk 1418, and an optical disk drive 1420 for reading from or writing to a removable optical disk 1422 such as a CD ROM, DVD ROM, or other optical media Hard disk drive 1414, magnetic disk drive 1416, and optical disk drive 1420 are connected to bus 1406 by a hard disk drive interface 1424, a magnetic disk drive interface 1426, and an optical drive interface 1428, respectively. The drives and their associated computer-readable media provide nonvolatile storage of computer-readable instructions, data structures, program modules and other data for the computer. Although a hard disk, a removable magnetic disk and a removable optical disk are described, other types of hardware-based computer-readable storage media can be used to store data, such as flash memory cards, digital video disks, RAMs, ROMs. and other hardware storage media.

A number of program modules may be stored on the hard disk, magnetic disk, optical disk, ROM, or RAM. These programs include operating system 1430, one or more application programs 1432, other programs 1434, and program data 1436. Application programs 1432 or other programs 1434 may include, for example, computer program logic (e.g., computer program code or instructions) for implementing resource update engine 106, resource designator 308, live resource migrator 310, resource updater 312, flowchart 200, flowchart 400, flowchart 500, flowchart 600, flowchart 700, and/or flowchart 800 (including any suitable step of flowchart 200), and/or further embodiments described herein.

A user may enter commands and information into the computing device 1400 through input devices such as keyboard 1438 and pointing device 1440. Other input devices (not shown) may include a microphone, joystick, game pad, satellite dish, scanner, a touch screen and/or touch pad, a voice recognition system to receive voice input, a gesture recognition system to receive gesture input, or the like. These and other input devices are often connected to processor circuit 1402 through a serial port interface 1442 that is coupled to bus 1406, but may be connected by other interfaces, such as a parallel port, game port, or a universal serial bus (USB).

A display screen 1444 is also connected to bus 1406 via an interface, such as a video adapter 1446. Display screen 1444 may be external to, or incorporated in computing device 1400. Display screen 1444 may display information, as well as being a user interface for receiving user commands and/or other information (e.g., by touch, finger gestures, virtual keyboard, etc.). In addition to display screen 1444, computing device 1400 may include other peripheral output devices (not shown) such as speakers and printers.

Computing device 1400 is connected to a network 1448 (e.g., the Internet) through an adaptor or network interface 1450, a modem 1452, or other means for establishing communications over the network. Modem 1452, which may be internal or external, may be connected to bus 1406 via serial port interface 1442, as shown in FIG. 14, or may be connected to bus 1406 using another interface type, including a parallel interface.

As used herein, the terms “computer program medium,” “computer-readable medium,” and “computer-readable storage medium” are used to refer to physical hardware media such as the hard disk associated with hard disk drive 1414, removable magnetic disk 1418, removable optical disk 1422, other physical hardware media such as RAMs, ROMs, flash memory cards, digital video disks, zip disks, MEMs, nanotechnology-based storage devices, and further types of physical/tangible hardware storage media. Such computer-readable storage media are distinguished from and non-overlapping with communication media (do not include communication media).

Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Embodiments are also directed to such communication media that are separate and non-overlapping with embodiments directed to computer-readable storage media.

As noted above, computer programs and modules (including application programs 1432 and other programs 1434) may be stored on the hard disk, magnetic disk, optical disk, ROM, RAM, or other hardware storage medium. Such computer programs may also be received via network interface 1450, serial port interface 1442, or any other interface type. Such computer programs, when executed or loaded by an application, enable computing device 1400 to implement features of embodiments discussed herein. Accordingly, such computer programs represent controllers of the computing device 1400.

Embodiments are also directed to computer program products comprising computer code or instructions stored on any computer-readable medium. Such computer program products include hard disk drives, optical disk drives, memory device packages, portable memory sticks, memory cards, and other types of physical storage hardware.

### IV. Additional Example Embodiments

In an embodiment, a method for increasing virtual machine availability during server updates comprises: designating a first resource set to include one or more servers needing an update: migrating from the first resource set a first set of virtual machines running on the one or servers in a live manner to a second resource set to convert the first resource set to an empty resource set, and such that the first set of virtual machines runs in a live manner on the second resource set; and performing the update on the one or more servers of the empty resource set to create an updated empty resource set.

In an embodiment, the further comprises: migrating a second set of virtual machines running in the live manner to the updated empty resource set.

In an embodiment, the further comprises: updating a network switch associated with the first resource set after all virtual machines running in the live manner on the first resource set are migrated from the first resource set.

In an embodiment, the designating comprises: selecting a server for the first resource set based on an amount of time one or more virtual machines have been running in the live manner on the server.

In an embodiment, the designating comprises: selecting a server for the first resource set based on a version of at least one of software or firmware operating on the server.

In an embodiment, the designating comprises: selecting a server for the first resource set based on a number of virtual machines running in the live manner on the server.

In an embodiment, the selecting comprises: selecting the server as having a lowest number of virtual machines running in the live manner of a plurality of servers.

In an embodiment, the migrating comprises: migrating the first set of virtual machines running in a live manner from the first resource set to the second resource set that is empty of virtual machines.

In an embodiment, the further comprises: migrating the first set of virtual machines running in a live manner from the first resource set to the second resource set that already includes at least one virtual machine running in a live manner.

In another embodiment, a system comprises: a resource update engine configured to increase virtual machine availability during server updates comprising: a resource designator configured to designate a first resource set to include one or more servers needing an update: a live resource migrator configured to migrate from the first resource set a first set of virtual machines running on the one or servers in a live manner to a second resource set to convert the first resource set to an empty resource set, and such that the first set of virtual machines runs in a live manner on the second resource set; and a resource updater configured to perform the update on the one or more servers of the empty resource set to create an updated empty resource set.

In an embodiment, the live resource migrator is further configured to migrate a second set of virtual machines running in the live manner to the updated empty resource set.

In an embodiment, the resource updater is further configured to update a network switch associated with the first resource set after all virtual machines running in the live manner on the first resource set are migrated from the first resource set.

In an embodiment, the resource designator is further configured to select a server for the first resource set based on an amount of time one or more virtual machines have been running in the live manner on the server.

In an embodiment, the resource designator is further configured to select a server for the first resource set based on a version of at least one of software or firmware operating on the server.

In an embodiment, the resource designator is further configured to select a server for the first resource set based on a number of virtual machines running in the live manner on the server.

In an embodiment, the resource designator is further configured to select the server as having a lowest number of virtual machines running in the live manner in a plurality of servers.

In an embodiment, the second resource set is empty of virtual machines prior to migrating the first set of virtual machines running on the one or more servers in a live manner to the second resource set to run in a live manner on the second resource set.

In an embodiment, the second resource set contains at least one running virtual machine prior to migrating the first set of virtual machines running on the one or more servers in a live manner to the second resource set to run in a live manner on the second resource set.

In another embodiment, a computer-readable storage medium having program instructions recorded thereon that, when executed by at least one processing circuit, perform a method on a first computing device for increasing virtual machine availability during server updates, the method comprising: designating a first resource set to include one or more servers needing an update; migrating from the first resource set a first set of virtual machines running on the one or servers in a live manner to a second resource set to convert the first resource set to an empty resource set, and such that the first set of virtual machines runs in a live manner on the second resource set; and performing the update on the one or more servers of the empty resource set to create an updated empty resource set.

In an embodiment, the method further comprises: migrating a second set of virtual machines running in the live manner to the updated empty resource set.

### V. Conclusion

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A method for increasing virtual machine availability during server updates, comprising:
designating a first resource set to include one or more servers needing an update;
migrating from the first resource set a first set of virtual machines running on the one or servers in a live manner to a second resource set to convert the first resource set to an empty resource set, and such that the first set of virtual machines runs in a live manner on the second resource set; and
performing the update on the one or more servers of the empty resource set to create an updated empty resource set.

2. The method of claim 1, further comprising:
migrating a second set of virtual machines running in the live manner to the updated empty resource set.

3. The method of claim 1, further comprising:
updating a network switch associated with the first resource set after all virtual machines running in the live manner on the first resource set are migrated from the first resource set.

4. The method of claim 1, wherein said designating comprises:
selecting a server for the first resource set based on an amount of time one or more virtual machines have been running in the live manner on the server.

5. The method of claim 1, wherein said designating comprises:
selecting a server for the first resource set based on a version of at least one of software or firmware operating on the server.

6. The method of claim 1, wherein said designating comprises:
selecting a server for the first resource set based on a number of virtual machines running in the live manner on the server.

7. The method of claim 6, wherein said selecting comprises:
selecting the server as having a lowest number of virtual machines running in the live manner of a plurality of servers.

8. The method of claim 1, wherein said migrating comprises:
migrating the first set of virtual machines running in a live manner from the first resource set to the second resource set that is empty of virtual machines.

9. The method of claim 1, further comprising:
migrating the first set of virtual machines running in a live manner from the first resource set to the second resource set that already includes at least one virtual machine running in a live manner.

10. A system, comprising:
a resource update engine configured to increase virtual machine availability during server updates comprising:
a resource designator configured to designate a first resource set to include one or more servers needing an update;
a live resource migrator configured to migrate from the first resource set a first set of virtual machines running on the one or servers in a live manner to a second resource set to convert the first resource set to an empty resource set, and such that the first set of virtual machines runs in a live manner on the second resource set; and
a resource updater configured to perform the update on the one or more servers of the empty resource set to create an updated empty resource set.

11. The system of claim 10, wherein the live resource migrator is further configured to migrate a second set of virtual machines running in the live manner to the updated empty resource set.

12. The system of claim 10, wherein the resource updater is further configured to update at least one of a network switch, an operating system, a system software, or a system firmware associated with the first resource set after all virtual machines running in the live manner on the first resource set are migrated from the first resource set.

13. The system of claim 10, wherein the resource designator is further configured to select a server for the first resource set based on an amount of time one or more virtual machines have been running in the live manner on the server.

14. The system of claim 10, wherein the resource designator is further configured to select a server for the first resource set based on a version of at least one of software or firmware operating on the server.

15. The system of claim 10, wherein the resource designator is further configured to select a server for the first resource set based on a number of virtual machines running in the live manner on the server.

16. The system of claim 15, wherein the resource designator is further configured to select the server as having a lowest number of virtual machines running in the live manner in a plurality of servers.

17. The method of claim 10, wherein the second resource set is empty of virtual machines prior to migrating the first set of virtual machines running on the one or more servers in a live manner to the second resource set to run in a live manner on the second resource set.

18. The method of claim 10, wherein the second resource set contains at least one running virtual machine prior to migrating the first set of virtual machines running on the one or more servers in a live manner to the second resource set to run in a live manner on the second resource set.

19. A computer-readable storage medium having program instructions recorded thereon that, when executed by at least one processing circuit, perform a method on a first computing device for increasing virtual machine availability during server updates, the method comprising:
designating a first resource set to include one or more servers needing an update;
migrating from the first resource set a first set of virtual machines running on the one or servers in a live manner to a second resource set to convert the first resource set to an empty resource set, and such that the first set of virtual machines runs in a live manner on the second resource set; and
performing the update on the one or more servers of the empty resource set to create an updated empty resource set.

20. The computer-readable storage medium of claim 19, wherein the method further comprises:
migrating a second set of virtual machines running in the live manner to the updated empty resource set.
